(19) United States
(12) Patent Application Publication
(10) Pub. No.: US 2003/0197618 A1
(43) Pub. Date: Oct. 23, 2003

(54) Smoke collector case

(76) Inventor: Alex Hsieh, Pan Chiao city (TW)

Correspondence Address: BROWDY AND NEIMARK, P.L.L.C., 624 NINTH STREET, NW, SUITE 300, WASHINGTON, DC, 20001-5303, US

(21) Appl. No.: 10/127,609

(22) Filed: Apr. 23, 2002

(51) Int. Cl. G08B 17/10

(52) U.S. Cl. 340/628

(57) ABSTRACT

A smoke collector case includes a hollow housing with a base and an upper cover. Pluralities of slots are mounted on the sidewall of the hollow housing. The hollow housing includes a plurality of first fins in an “I” manner that are spaced apart from one another and set approximately near to the sidewall of the hollow housing. The hollow housing further includes a plurality of second fins, which are shaped in a bar manner and disposed between every two first fins.

### BACKGROUND OF THE INVENTION

1. Field of the Invention

The invention relates to a smoke collector case and, more particularly, to a smoke collector case that can provide the smoke detection more effectively and quickly.

2. Description of the Related Art

Smoke detector devices play an important role in warning any fire occurrence in modern civil buildings. Smoke detectors are set on the ceiling of these buildings and connected to central monitoring systems. If any fire occurs, smoke detectors will send corresponding signals to the central monitoring systems.

FIG. 1 is a schematic diagram illustrating a smoke detector device known in the prior art. The known smoke detector device usually includes a smoke detector 15 placed in a smoke collector case 10, traditionally shaped in a round and hollow manner. There are slots (not shown) in sidewall of the hollow housing 11. The purpose of setting these slots is for passage of the smoke from fire occurrences, as this result, the smoke detector 15 can detect these fire occurrences. The hollow housing 11 internally includes a plurality of fins 12, or labyrinth, which are spaced apart from one another and set near to the sidewall of hollow housing 11. The fins 12 are substantially shaped in a “7” manner, and each of these fins 12 includes an outer sidewall 13 and inner sidewall 14. There is an acute angle formed between the inner sidewall 13 and outer sidewall 14. Fins 12 define a smoke path that guides the smoke to the smoke detector 15 within the hollow housing 11.

With the above smoke collector case 10, smoke generally has to pass along the direction parallel to the outer sidewall 13 for the purpose of being of the fins 12 to be effectively guided to the smoke detector 15. Consequently, the smoke collection is directionally limited. Since direction of fire smoke is generally not predictable, the above smoke collector case 10 may be deficient to guide the smoke when the worst scenario, i.e., the smoke passes along the direction perpendicular to the outer sidewall 13, occurs, leading to the amount of the smoke able to be guided to the smoke collector is reduced. As this result, the smoke detection capability is less effective.

### SUMMARY OF THE INVENTION

It is therefore a principal object of the invention to provide a smoke collector case that can effectively collect and guide the smoke to the smoke detector mounted therein, so that the smoke detection is much more effective.

To accomplish the above and other objectives, the invention provides a smoke collector case that comprises a hollow housing having a smoke detector inside. Slots are mounted in sidewall of the hollow housing. The hollow housing include a plurality of first fins placed in an “I” shape inside, and these first fins are spaced apart from one another and set near to the sidewall of the hollow housing. The hollow housing further includes a plurality of second fins respectively disposed between each of first fins.

It is an advantage of the present invention that the fire smoke can be guided to the smoke detector more easily through the setting of the aforementioned first and second fins, so as to provide a fire smoke detection more effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The drawings included herein provide a further understanding of the invention. A brief introduction of the drawings is as follows:

FIG. 1 is a schematic diagram of a smoke collector case known in the prior art;

FIG. 2 is an exploded view of a smoke collector case according to the present invention;

FIG. 3 is a schematic diagram of the present invention;

FIG. 4 is a schematic diagram of the upper cover according to the present invention; and

FIG. 5 and FIG. 6 are schematic diagrams while the present invention is operated

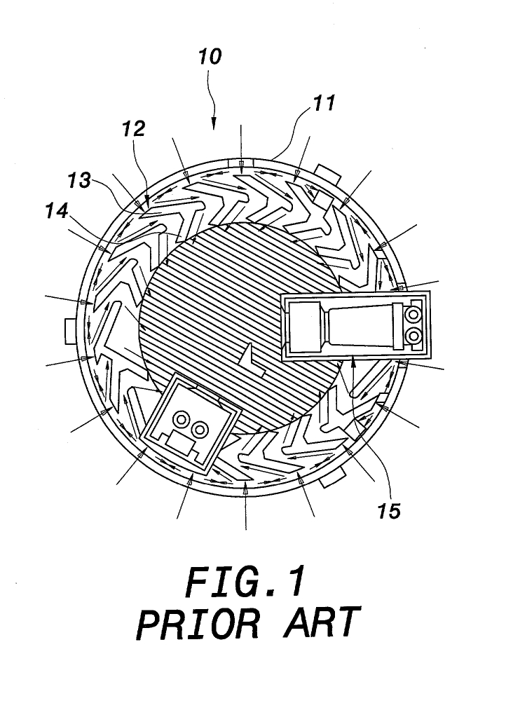

### DETAILED DESCRIPTION OF THE EMBODIMENTS

Wherever possible in the following description, like reference numerals will refer to like elements and parts unless otherwise illustrated.

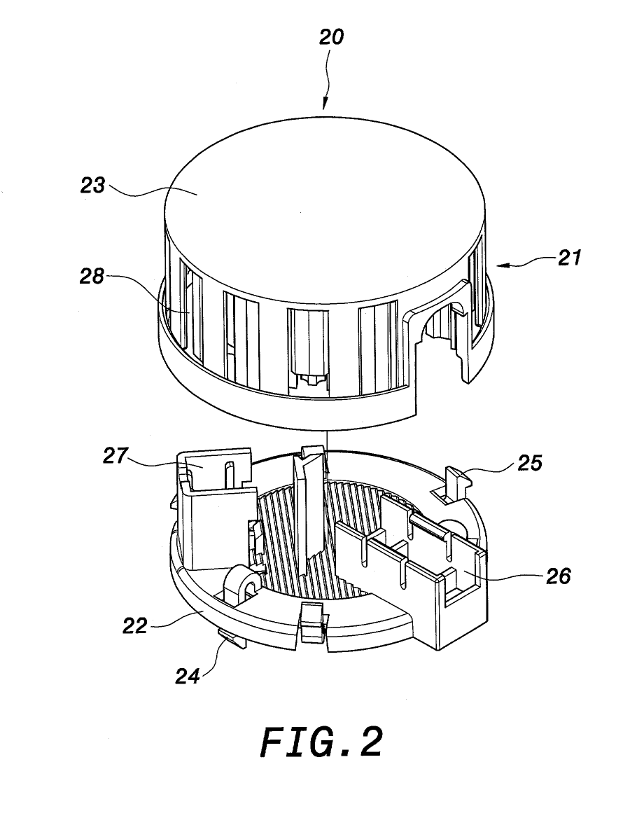

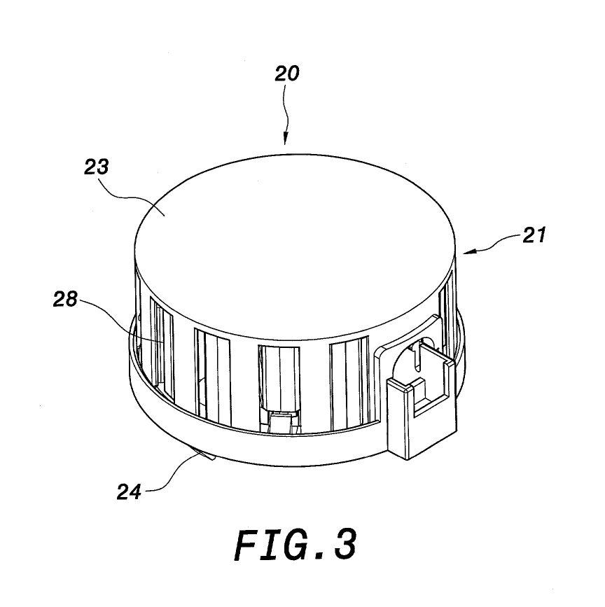

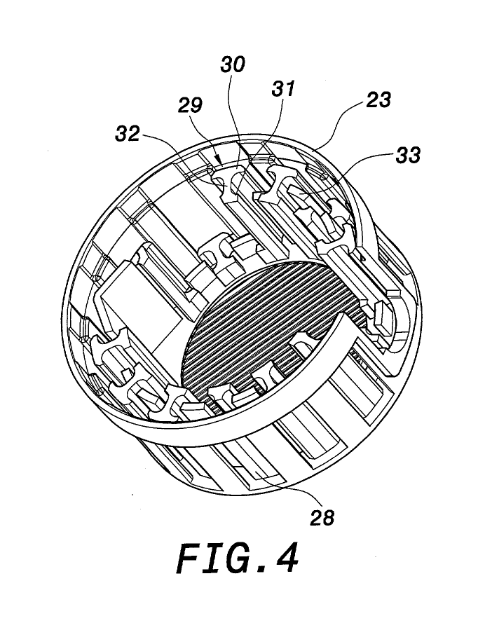

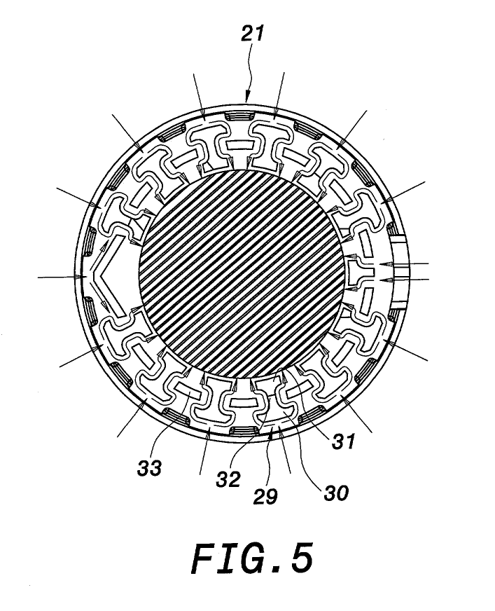

Referring to FIG. 2, FIG. 3, and FIG. 4, the present invention provides a smoke collector case 20 that comprises a cylindrical hollow housing 21. The hollow housing 21 includes a base 22 and an upper cover 23. The base 22 is disk-shaped and further includes a plurality of first fastening members 24 and second fastening members 25, respectively protruding from the bottom and top surface thereof. The second fastening members 25 are for connecting with the upper cover 23. The base 22 includes a first fixation base 26 and a second fixation base 27 used for mounting the smoke detector.

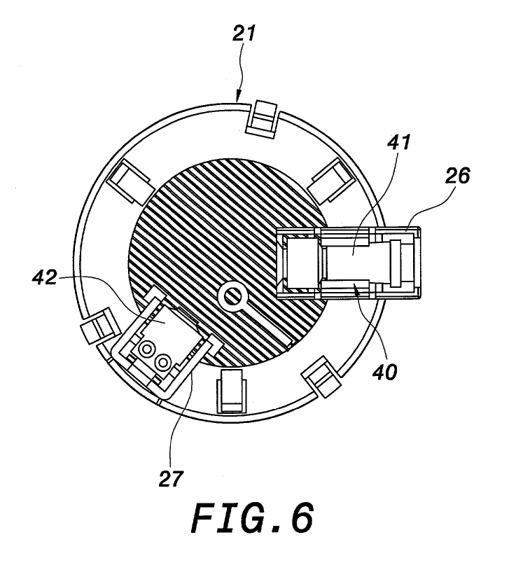

The upper cover 23 is cylindrical and opened at the bottom portion. Slots 28 are mounted on sidewall of the upper cover 23 and are for the purpose of being the passage of fire smoke. As this result, the fire smoke can be detected by the smoke detector 40 inside of the hollow housing 21 as shown as in FIG. 6. includes a plurality of slots 28 through which smoke can penetrate within the case 21 to the smoke detector 40. The upper cover 23 internally includes a plurality of first fins 29, like a “labyrinth”, that are spaced apart from one another and set near to the sidewall of the upper cover 23. The placement of first fins 29 hence defines a smoke path to guide the fire smoke is guided to the smoke detector 40. The first fins 29 are shaped in an “I” manner cross-sectionally. Each first fin 29 has an outer sidewall 30 and an inner sidewall 31 that are further connected to each other via a connecting portion 32 between the outer and inner sidewall 30 and 31. A second fin 33 is placed between every two first fins 29. The second fins 33 are shaped in a bar manner cross-sectionally. The upper cover 23 is fixedly fastened to the base 22 through the second fastening members 25, thereby defining a preferred embodiment of the invention.

Referring to FIG. 6, a smoke detector 40 is installed within the smoke collector case 20. The smoke detector 40 can be of any known type. This embodiment illustrates a smoke detector of the light scattering type which includes a light source 41 and a light receiver element 42, both of whom are mounted on the first and second fixation bases 26 and 27. The light emitted from the light source 41 does not reach the light receiver element 42 placed in a biased position relative to the light source 41 if no smoke presence. The presence of smoke scatters the light emitted from the light source 41, therefore, that light reaches the light receiver element 42, thereby triggering a warning signal that indicates the potential presence of fire smoke.

According to another example not illustrated, the smoke detector may also be of the light intensity sensing type. This kind of smoke detector also employs a LED as the light source and a photo-transistor as the light receiver element. With the presence of fire smoke, the light intensity from the LED will be attenuated, thereby detecting the presence of fire smoke.

Still according to another example not illustrated, the smoke detector may be of the ionic type, typically providing a pair of electrodes. The air between these electrodes will be ionized when an alpha ray is applied to the gap between two electrodes, thereby creating a responsive electric current. The responsive current will reduce if the smoke between electrodes adsorbs a portion of the ions, representing fire occurrences.

As described above, the invention therefore principally provides a smoke collector case with “I” shaped first fins 29 and second fins 33 disposed between these first fins 29. Fire smoke can therefore pass through the smoke collector case from any direction, and smoke detection can be more efficiently and quickly.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A smoke collector case comprising a hollow housing having a plurality of slots formed in the sidewall thereof and a plurality of first fins in an “I” manner therewithin, said first fins having a plurality of second fins therebetween.

2. The smoke collector case of claim 1, wherein said hollow housing is formed of a base and an upper cover.

3. The smoke collector case of claim 2, wherein said base comprises a plurality of first fastening members on the bottom surface thereof and a plurality of second fastening members on the top surface thereof for fastening with said upper cover.

4. The smoke collector case of claim 2, wherein said base further comprises a fixation base having mounted a smoke detector therein.

5. The smoke collector case of claim 2, wherein said slots are mounted on the upper cover.

6. The smoke collector case of claim 2, wherein said first and second fins are mounted on the upper cover.

7. The smoke collector case of claim 1, wherein said each first fin comprises an outer sidewall, an inner sidewall and a connection portion for connecting said outer wall and said inner wall.

8. The smoke collector case of claim 1, wherein said second fins are shaped in a bar manner.
